(19) United States
(12) Patent Application Publication
(10) Pub. No.: US 2025/0130702 A1
(43) Pub. Date: Apr. 24, 2025

(54) IMAGE CROPPING

(71) Applicant: CARESTREAM HEALTH, INC., Rochester, NY (US)

(72) Inventors: Joe LU, Guangzhou (CN); Wendy XIAO, Shanghai (CN); Mark GU, Shanghai (CN); Qi WANG, Shanghi (CN)

(21) Appl. No.: 18/916,802

(22) Filed: Oct. 16, 2024

Related U.S. Application Data
(60) Provisional application No. 63/592,670, filed on Oct. 24, 2023.

(51) Int. Cl. G06F 3/04845

(52) U.S. Cl. CPC G06F 3/04845

(57) ABSTRACT

A method of defining a viewing region on an electronic display is performed by selecting only two points on the display and forming the viewing region such that the selected two points are located on a border of the viewing region. The selected two points may be configured to be located at opposite corners of a rectangular viewing region.

### CROSS REFERENCE TO RELATED APPLICATIONS

This application claims priority to U.S. Patent Application Ser. No. 63/592,670, filed Oct. 24, 2023, in the name of Lu et al., and entitled IMAGE CROPPING, which is hereby incorporated by reference herein in its entirety.

### BACKGROUND OF THE INVENTION

The subject matter disclosed herein relates to post-x-ray exposure image pre-processing cropping. Existing x-ray image editing systems allow an operator to see a captured x-ray image on a console when the exposure is completed, after which the operator may send the image to a picture archiving and communication system (PACS) after simple processing.

When processing the image, common image editing software may automatically activate an eight-point cropping function—one point per each of four sides and one point per each of four corners—as shown in FIG. 1A, which illustrates a four-sided rectangular viewing, or cropping, region. The operator may click, drag, and complete the image cropping using any of the eight automatically generated points on the borders and/or corners.

We found that if an operator dragged any one of the four corners of the rectangle when clicking on a border, it would cause the original rectangle, such as shown in FIG. 1A, to become an irregular quadrilateral, as exemplified in FIG. 1B. Then it becomes difficult to restore the quadrilateral to a preferred shape such as the original rectangle, i.e., all four corners at right angles. This also happens when automatically generated borders have irregular quadrilateral shapes.

The discussion above is merely provided for general background information and is not intended to be used as an aid in determining the scope of the claimed subject matter.

### BRIEF DESCRIPTION OF THE INVENTION

A method of defining a viewing region on an electronic display is performed by selecting only two points on the display and forming the viewing region such that the selected two points are located on a border of the viewing region. The selected two points may be configured to be located at opposite corners of a rectangular viewing region.

In one embodiment, a viewing region on an electronic display can be defined by selecting only two points on the display and forming the viewing region whereby the selected two points are located on a border of the viewing region, such as at opposite corners of a rectangular viewing region.

In one embodiment, a viewing region on an electronic display having an eight-point cropping interface, mode, or function, can be formed by activating a two-point viewing area interface, function, or mode, that simultaneously deactivates the eight-point cropping interface. After selecting only two points on the electronic display and automatically forming a rectangular viewing region, wherein the selected two points are located on a border of the rectangular viewing region, the eight-point cropping interface is automatically reactivated for use.

In one embodiment, an electronic display system may include a processor programmed to activate a two-point viewing area function and to simultaneously deactivate an eight-point cropping interface provided with the display system. An operator may use the two-point viewing area interface by selecting only two points on the electronic display in order to form a rectangular viewing region wherein the selected two points are located on a border of the viewing region.

In one embodiment, this invention allows an operator to activate a two-point viewing area drawing mode, such as by using a finger on a touch screen, and/or a mouse, and/or a button. The operator may use a mouse to click on, or use a finger to select, two points in an area of the image to create a new rectangular viewing area, wherein the display system uses a line connecting the selected two points to form a diagonal of the rectangular viewing area. This solution does not cause the screen to drag and drop and enables the operator to use this feature easily and quickly, e.g., while wearing gloves.

This feature also provides a method to crop a finished x-ray image. An operator may also clearly designate the state of the corners in the image after clicking a button to disable eight-point cropping functions which uses draggable points in the corners of the image.

The summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings below are intended to be drawn neither to any precise scale with respect to relative size, angular relationship, relative position, or timing relationship, nor to any combinational relationship with respect to interchangeability, substitution, or representation of a required implementation, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIGS. 1A-1B illustrate a difficulty of prior eight-point cropping functions;

FIGS. 2A-2C show a screen feature of simultaneously activating a two-point viewing area function and disabling an eight-point cropping function, with icon for activating the two-point viewing area function;

FIGS. 3A-3F illustrate a touch screen embodiment of the invention; and

FIG. 4 illustrates a display system for implementing the invention.

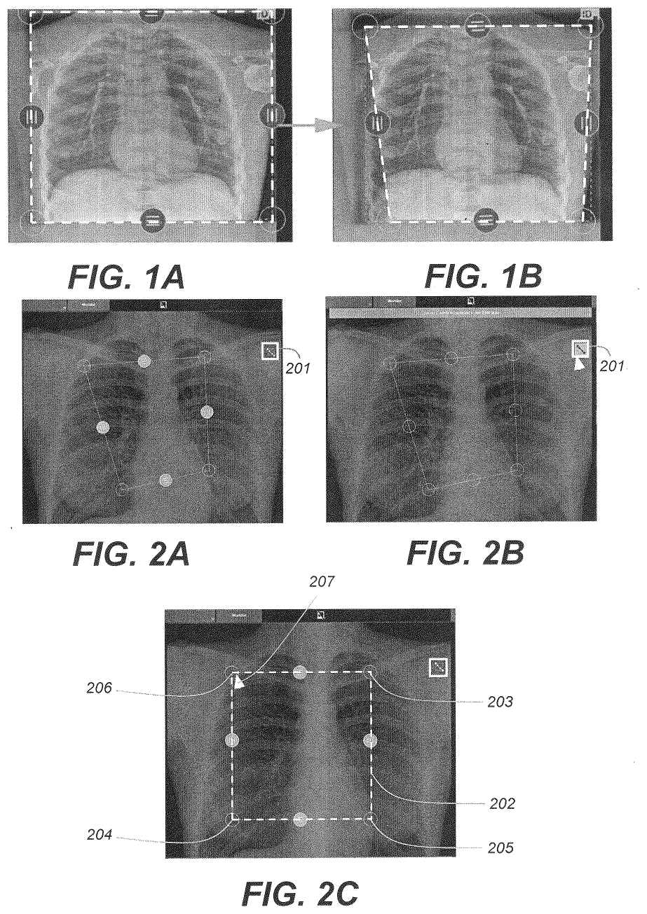

### DETAILED DESCRIPTION OF THE INVENTION

With reference to FIGS. 2A-2C, one embodiment of the present invention provides a user interface wherein the two-point viewing area function is activated by selecting, or clicking on, an on-screen icon, or control button, 201, such as by using a mouse. The control button 201 as shown in FIG. 2A appears on the screen to enable an operator to select the two-point viewing area mode. FIG. 2A shows an active eight-point cropping mode having draggable buttons on each of the four sides and four corners of a selectable viewing area. If the operator desires to select two points to form the rectangular viewing area, the control button 201 may be clicked, selected or activated as shown in FIG. 2B, which disables the eight draggable points, or buttons, in the border area as shown in FIG. 2B and simultaneously activates the two-point viewing area mode. In this two-point selection mode, selecting or clicking on any two points in the image generates a new rectangular viewing area, shown by the dashed line rectangle 202 in FIG. 2C, based on the two selected points. The two selected points may include 203 and 204, or 205 and 206, for example, using a mouse controlled cursor 207. The line between the two selected points forms a diagonal for forming the rectangular viewing area 202. After the viewing area is generated and displayed, this two-point viewing area mode is automatically exited and the other draggable buttons are reactivated in the initial eight-point cropping mode as shown in FIG. 2C. Hence, the use of the two-point viewing area mode allows an operator to quickly form a rectangular viewing region.

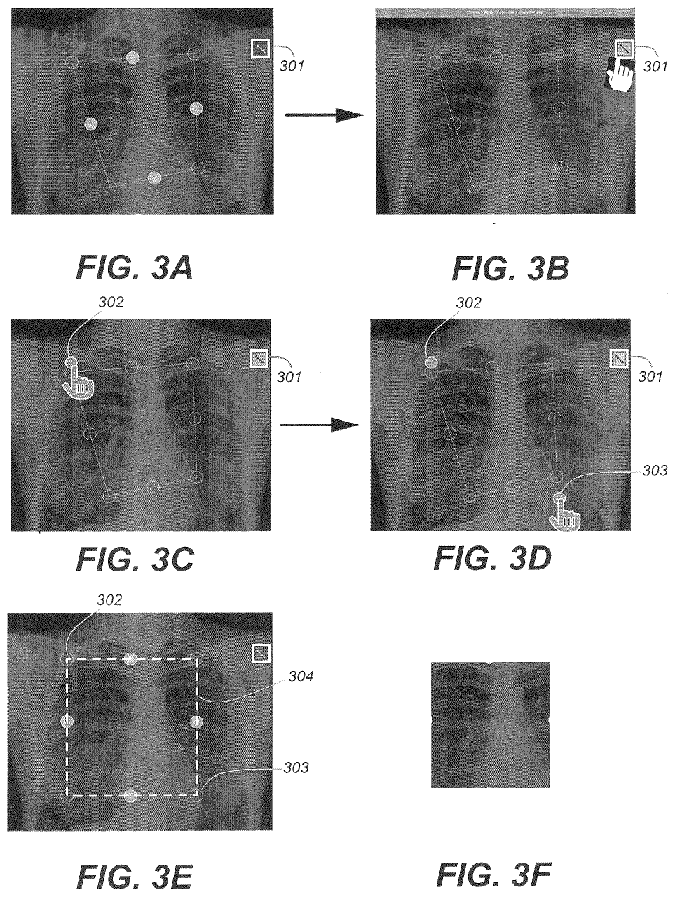

In a touch screen embodiment, as shown in FIGS. 3A-3F, an active eight-point cropping function is illustrated in FIG. 3A with an icon 301 for activating the two-point viewing area mode of the present invention. An operator may simultaneously activate the two-point viewing area mode and deactivate the eight-point cropping function by touching the icon 301 as shown in FIG. 3B. After activating the two-point viewing area mode, the operator may select two points to form the rectangular viewing area, such as by touching point 302 and point 303 as shown in FIGS. 3C and 3D. The two selected points 302, 303, serve as the border points used to form rectangular viewing area 304 as shown in FIG. 3E. As also shown in FIG. 3E, the initial eight-point cropping function is automatically reactivated when the rectangular viewing area 304 is generated. Now the operator can continue to drag any of the eight points (four per each side and four per each corner) on the display screen, in the eight-point cropping mode, to crop the viewing area as shown in FIG. 3F.

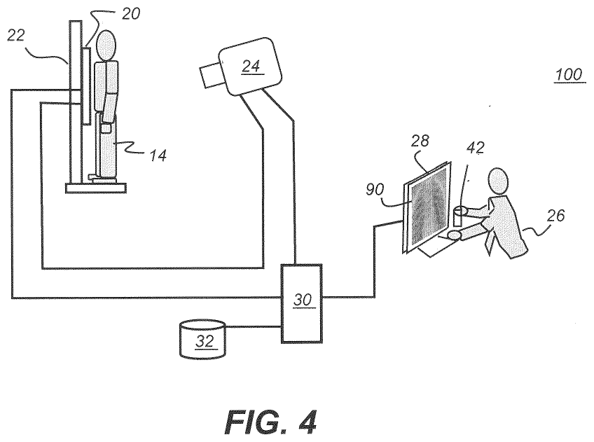

The schematic diagram of FIG. 4 shows a radiography system 100 for x-ray imaging of a human body. System 100 uses a digital radiographic (DR) detector 20 for image capture and provides computational logic for performing image processing on the captured image. In the radiography system 100 shown in FIG. 4, a patient 14 is positioned adjacent DR detector 20, which is mounted on a bucky or other support 22, and is exposed to radiation from an x-ray source 24, whereby detector 20 captures a DR image of a portion of patient 14, such as shown in the figures of the present patent application, for example. The exposure is initiated by the operator 26 using an operator control 42 that is in signal communication with a control logic processor 30 that can initiate exposure and the image acquisition described herein. Practitioner 26 controls the setup and operation from a workstation 28 having a display 90 or other control console. Control logic processor 30 is in signal communication with other components of apparatus 100, such as DR detector 20 and x-ray source 24, and provides the needed control signals for exposure, data acquisition, processing, storage, and transmission. The captured radiographic image of patient 14 may be displayed on display 90 for viewing and use by operator 26 in the viewing area modes and cropping modes as described herein. A memory 32 or other storage apparatus, in signal communication with control logic processor 30, may include the user interface and other program modules for implementing operation of the invention as explained herein and other programmed methods described herein under operational control of processor 30.

As will be appreciated by one skilled in the art, aspects of the present invention may be embodied as a programmed processor system, method, computer program product, or module. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer, for example, through the internet.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of defining a viewing region on an electronic display, the method comprising:
selecting only two points on the display; and
forming the viewing region wherein the selected two points are located on a border of the viewing region.

2. The method of claim 1, further comprising forming the viewing region wherein the selected two points are located at opposite corners of a rectangular viewing region.

3. The method of claim 1, further comprising selecting the only two points within an image displayed on the electronic display, and cropping the displayed image according to the formed viewing region.

4. The method of any of claim 2, further comprising simultaneously activating an eight-point cropping function on the viewing region after the step of forming the rectangular viewing region.

5. The method of claim 2, wherein the eight-point cropping function is configured to adjust any one of four sides of the rectangular viewing region and any one of four corners of the rectangular viewing region.

6. The method of claim 4, further comprising deactivating the eight-point cropping function before the step of forming the rectangular viewing region.

7. The method of claim 6, further comprising disabling any other cropping function before the step of forming the rectangular viewing region.

8. A method of defining a viewing region on an electronic display having an active eight-point cropping interface, the method comprising:
activating a two-point function and simultaneously deactivating the eight-point cropping interface;
selecting only two points on the electronic display; and
forming the viewing region wherein the selected two points are located on a border of the viewing region.

9. The method of claim 8, further comprising forming the viewing region wherein the selected two points are located at opposite corners of a rectangular viewing region.

10. The method of claim 8, further comprising selecting the only two points within an image displayed on the electronic display, and cropping the displayed image according to the formed viewing region.

11. The method of claim 9, further comprising reactivating the eight-point cropping function on the viewing region after the step of forming the rectangular viewing region.

12. The method of claim 9, wherein the eight-point cropping function is configured to adjust any one of four sides of the rectangular viewing region and any one of four corners of the rectangular viewing region.

13. The method of claim 8, further comprising deactivating any other cropping interface before the step of forming the viewing region.

14. An electronic display system comprising a processor programmed to:
activate a two-point viewing area function and simultaneously deactivate an eight-point cropping interface;
receive a selection of only two points at the electronic display system; and
form a viewing area wherein the selected two points are located on a border of the viewing area.

15. The system of claim 14, wherein the processor is further programmed to form the viewing area wherein the selected two points are located at opposite corners of a rectangular viewing area.

16. The system of claim 14, wherein the processor is further programmed to receive the selection of only the two points within an image displayed by the electronic display system, and to crop the displayed image according to the formed viewing area.

17. The system of claim 15, wherein the processor is further programmed to reactivate the eight-point cropping interface on the rectangular viewing area after the step of forming the rectangular viewing area.

18. The system of claim 15, wherein the processor is further programmed to adjust any one of four sides of the rectangular viewing area and any one of four corners of the rectangular viewing area.

19. The system of claim 14, wherein the processor is further programmed to deactivate any other cropping interface before the step of forming the viewing area.
